(19) United States
(12) Patent Application Publication
(10) Pub. No.: US 2026/0235798 A1
(43) Pub. Date: Aug. 13, 2026

(54) MULTI-CORE FIBER FOR COMMUNICATION, AND OPTICAL COMMUNICATION DEVICE

(71) Applicant: FUJIKURA LTD., Tokyo (JP)

(72) Inventor: Takuya Oda, Sakura-shi, Chiba (JP)

(73) Assignee: FUJIKURA LTD., Tokyo (JP)

(21) Appl. No.: 19/153,767

(22) PCT Filed: Dec. 26, 2023
(86) PCT No.: PCT/JP2023/046727

§ 371 Date: Aug. 5, 2025

(30) Foreign Application Priority Data
Feb. 9, 2023 (JP) 2023-018554

(51) Int. Cl. G02B 6/02; G02B 6/42

(52) U.S. Cl. CPC G02B 6/02042; G02B 6/4246

(57) ABSTRACT

A multi-core fiber for communication includes transmission paths that each include a single core or multiple cores mode-coupled to each other and a common cladding that surrounds an outer circumferential surface of the single core of each of the transmission paths or each of the multiple cores of each of the transmission paths. A first transmission path of the transmission paths closest to a center of the common cladding propagates light in a higher-order mode than a second transmission path of the transmission paths farthest from the center.

### BACKGROUND

### Technical Field

The present invention relates to a multi-core fiber for communication and an optical communication device.

### Discussion of the Background

It is known to transmit a plurality of signals by means of light propagating in the respective cores by using a multi-core fiber in which outer circumferences of a plurality of cores are surrounded by one cladding. Furthermore, mode division multiplex communication is known in which light beams in a plurality of modes are propagated to one core and signals are transmitted by the light beams in the respective modes in order to transmit more signals. Patent Literature 1 describes such a multi-core fiber.
Patent Literature 1: WO 2013/021697 A

In a case where the mode division multiplex communication is performed using the multi-core fiber as described above, an amount of signals to be propagated can be increased. Incidentally, in a case where multi-core fibers are connected to each other, alignment is performed in a rotation direction of axial centers of the multi-core fibers to be connected, and cores of the respective multi-core fibers are opposed to each other. Therefore, when misalignment occurs in the rotation direction, positional displacement easily occurs in the core positioned on an outer circumferential side of the cladding. In a case where the positional displacement of the cores connected to each other occurs and light in a higher-order mode propagates to the cores, the light in the higher-order mode is easily coupled to light in another mode at a connection portion, and transmission quality of the light is easily deteriorated.

### SUMMARY

One or more embodiments provide a multi-core fiber for communication and an optical communication device capable of suppressing deterioration in transmission quality of light while increasing an amount of signals to be propagated.

A first aspect of one or more embodiments is a multi-core fiber for communication including: a plurality of transmission paths that each includes one core or a plurality of cores mode-coupled to each other; and a common cladding that surrounds an outer circumferential surface of each of the cores, in which the transmission path (first transmission path) nearest to a center of the common cladding is capable of propagating light in a higher-order mode than the transmission path (second transmission path) farthest from the center.

According to such a multi-core fiber for communication, mode division multiplex communication can be performed in the transmission path capable of propagating light in a plurality of modes. Therefore, an amount of signals to be propagated can be increased as compared with a multi-core fiber for communication in which each of the transmission paths includes a single mode core. Furthermore, as described above, when positional displacement occurs in a core through which the light in a higher-order mode propagates in a connection portion with another multi-core fiber for communication, the light in the higher-order mode is easily coupled to light in another mode. However, in the multi-core fiber for communication, the transmission path nearest to the center of the common cladding propagates the light in a higher-order mode than the transmission path farthest from the center of the common cladding. That is, in the transmission path farthest from the center of the common cladding, the number of modes of light propagating is smaller than that in the transmission path nearest to the center of the common cladding. Therefore, even in a case where the transmission path on the outer circumferential side of the common cladding causes positional displacement at the connection portion, the light to be propagated is less likely to be coupled to the light in another mode as compared with a case where the transmission path farthest from the center of the common cladding propagates light in the same number of modes as the transmission path nearest to the center of the common cladding. Therefore, according to the multi-core fiber for communication, it is possible to suppress deterioration in transmission quality of the light to be propagated.

A second aspect of one or more embodiments is the multi-core fiber for communication according to the first aspect, in which the nearer the transmission path is to the center of the common cladding, light in a higher-order mode can be propagated.

According to such a multi-core fiber for communication, the number of modes of light to be propagated is smaller in a transmission path on the outer circumferential side where positional displacement is more likely to be large at the connection portion with the another multi-core fiber for communication, so that the deterioration in the transmission quality of the light to be propagated can be further suppressed.

A third aspect of one or more embodiments is the multi-core fiber for communication according to the first aspect or the second aspect, in which the transmission paths arranged at equal distances from the center of the common cladding are capable of propagating light in the same mode.

According to such a multi-core fiber for communication, in a case where misalignment in a rotation direction occurs at the connection portion, an influence of the mode coupling can be substantially the same between the transmission paths arranged at the equal distances from the center of the common cladding, and correction can be facilitated by signal processing.

A fourth aspect of one or more embodiments is the multi-core fiber for communication according to any one of the first to third aspects, in which the transmission paths are arranged so as to be rotationally symmetric about the center of the common cladding.

According to such a multi-core fiber for communication, when the multi-core fiber for communication is connected to the another multi-core fiber for communication, alignment in the rotation direction is easy.

A fifth aspect of one or more embodiments is the multi-core fiber for communication according to any one of the first to fourth aspects, in which the transmission path includes one of the cores and is arranged in a closest packing state.

According to such a multi-core fiber for communication, a common cladding diameter can be made small as compared with a multi-core fiber having the same number of cores in which cores are not arranged in a closest packing state.

A sixth aspect of one or more embodiments is the multi-core fiber for communication according to any one of the first to fourth aspects, in which the transmission path including the plurality of cores mode-coupled to each other is arranged at the center of the common cladding.

A seventh aspect of one or more embodiments is the multi-core fiber for communication according to any one of the first to third and sixth aspects, in which the transmission path capable of propagating the light in a higher-order mode is arranged at the center of the common cladding, and the transmission path arranged at a position other than the center is a single mode core.

According to such a multi-core fiber for communication, in a case where misalignment in the rotation direction occurs at the connection portion, light propagating through the core in which positional displacement occurs is less likely to be coupled to light in another mode. Therefore, according to the multi-core fiber for communication, it is possible to further suppress the deterioration in the transmission quality of the light to be propagated.

An eighth aspect of one or more embodiments is the multi-core fiber for communication according to any one of the first to sixth aspects, in which the transmission path farthest from the center of the common cladding is a single mode core.

According to such a multi-core fiber for communication, it is possible to suppress mode coupling of light propagating through the transmission path arranged on an outermost circumference where positional displacement tends to be large in the connection portion.

A ninth aspect of one or more embodiments is an optical communication device including: a multi-core fiber for communication including a plurality of transmission paths that each includes one core or a plurality of cores mode-coupled to each other, and a common cladding that surrounds an outer circumferential surface of each of the cores; and a transceiver that performs at least one of transmission and reception of light by the plurality of transmission paths, in which the transmission path nearest to a center of the common cladding is capable of propagating light in a higher-order mode than the transmission path farthest from the center.

According to such an optical communication device, as in the first aspect, it is possible to suppress the deterioration in the transmission quality of the light while increasing the amount of signals to be propagated.

A tenth aspect of one or more embodiments is the optical communication device according to the ninth aspect, in which the transceiver transmits light to a part of the transmission paths of the multi-core fiber for communication and receives light propagating through another part of the transmission paths.

According to such an optical communication device, it is possible to transmit and receive the light using the one multi-core fiber for communication.

An eleventh aspect of one or more embodiments is the optical communication device according to the tenth aspect, in which, in a case where the transceiver counts light beams in the respective modes propagating through the transmission paths as different light beams, a sum of the number of light beams to be transmitted to the transmission paths by superimposing signals and the number of light beams to be received from the transmission paths on which signals are superimposed is an even number.

In the optical communication, a sum of the number of transmission ports and the number of reception ports of the light may be an even number. According to such an optical communication device, even in such a case, it is possible to suppress waste and transmit and receive the light using the one multi-core fiber for communication.

A twelfth aspect of one or more embodiments is the optical communication device according to the eleventh aspect, in which, in a case where the transceiver counts light beams in the respective modes propagating through the transmission path as different light beams, the transceiver superimposes signals on each of light beams (outgoing light beams) of the number of multiples of 2 and transmits the light beams to at least one of the transmission paths, and receives each of the light beams (incoming light beams) of the number of multiples of 2 on which signals are superimposed from at least one of the transmission paths.

In optical communication, each of the number of transmission ports and the number of reception ports of light may be a multiple of 2. According to such an optical communication device, even in such a case, it is possible to transmit and receive the light using the one multi-core fiber for communication.

A thirteenth aspect of one or more embodiments is the optical communication device according to the eleventh or twelfth aspect, in which a sum of the number of light beams on which the signals are superimposed to be transmitted to the transmission paths by the transceiver is equal to a sum of the number of light beams on which the signals are superimposed to be received from the transmission paths.

In optical communication, the number of transmission ports and the number of reception ports of the light may be equal to each other. According to such an optical communication device, even in such a case, it is possible to transmit and receive the light using the one multi-core fiber for communication.

A fourteenth aspect of one or more embodiments is the optical communication device according to any one of the ninth to thirteenth aspects, in which the transceiver treats, as one mode, light in one degeneration mode propagating through the transmission path capable of propagating light in the degeneration mode.

By treating the light in the degeneration mode as one light in this manner, intensity of the light can be increased, signal/noise (S/N) can be improved, and communication quality can be improved. Furthermore, signal processing such as multiple-input-multiple-output (MIMO) on the reception side can be reduced as compared with a case where light in the degeneration mode is treated as light in two modes.

A fifteenth aspect of one or more embodiments is the optical communication device according to any one of the ninth to fourteenth aspects, in which the transceiver does not use light in a part of the modes of the transmission paths capable of propagating light in a plurality of modes.

As described above, according to one or more embodiments, there are provided the multi-core fiber for communication and the optical communication device capable of suppressing the deterioration in the transmission quality of the light while increasing the amount of signals to be propagated.

### BRIEF DESCRIPTION OF THE DRAWINGS

FIG. 1 is a view illustrating an optical communication system.

FIG. 2 is a cross-sectional view perpendicular to a longitudinal direction of a multi-core fiber for communication.

FIG. 3 is a view illustrating a state of a cross section perpendicular to the longitudinal direction of a first modification of the multi-core fiber for communication.

FIG. 4 is a view illustrating a state of the cross section perpendicular to the longitudinal direction of a second modification of the multi-core fiber for communication.

FIG. 5 is a view illustrating a state of the cross section perpendicular to the longitudinal direction of a third modification of the multi-core fiber for communication.

FIG. 6 is a view illustrating a state of the cross section perpendicular to the longitudinal direction of a fourth modification of the multi-core fiber for communication.

### DESCRIPTION OF THE EMBODIMENTS

Hereinafter, embodiments of a multi-core fiber for communication and an optical communication device will be described in detail with reference to the drawings. The embodiments exemplified below is intended to facilitate understanding of the present invention, and is not intended to be construed as limiting the present invention. The present invention can be modified and improved from the embodiments without departing from the scope thereof. Note that, for easy understanding, scales described in the respective drawings may be different from scales described in the following description.

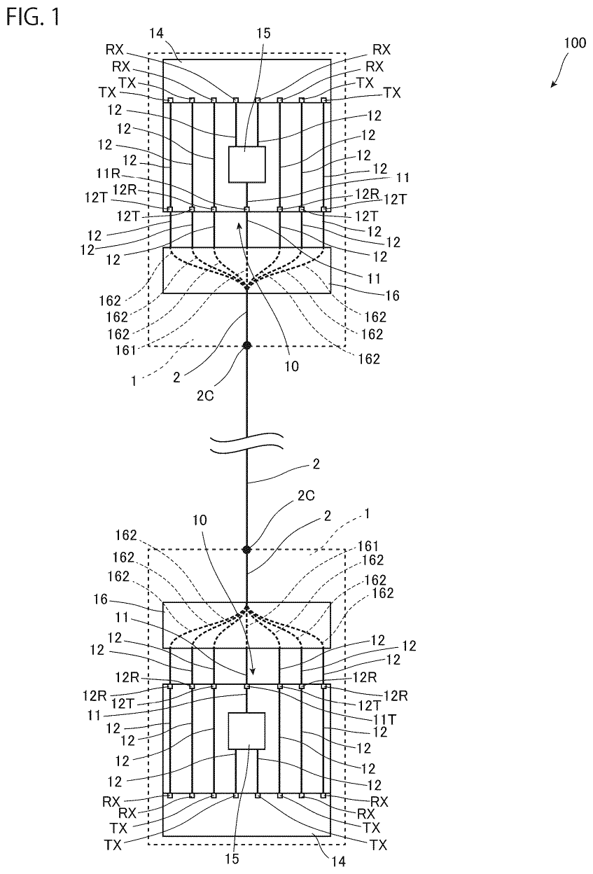

FIG. 1 is a view illustrating an optical communication system of one or more embodiments. As illustrated in FIG. 1, an optical communication system 100 of one or more embodiments includes a pair of optical communication devices 1 and multi-core fibers for communication 2 as main configurations.

The pair of optical communication devices 1 indicated by broken lines in FIG. 1 have substantially the same configuration unless otherwise specified. Therefore, one of the optical communication devices 1 positioned on a lower side in the drawing will be described. The optical communication device 1 includes a transceiver 10, a fan-in/fan-out device 16, and the multi-core fiber for communication 2 as main configurations.

The transceiver 10 includes a circuit unit 14 and a mode multiplexing/demultiplexing unit 15 as main configurations. The circuit unit 14 includes each of a plurality of ports TX and RX to which optical fibers 12 are connected. The port TX is a port that transmits light on which a signal is superimposed, and the port RX is a port that receives light on which a signal is superimposed. In this example, the number of each of the ports TX and RX is four. The light used for this communication is, for example, C-band light having a wavelength of 1530 nm to 1565 nm. Note that 0-band light having a wavelength of 1269 nm to 1360 nm, L-band light having a wavelength of 1565 nm to 1625 nm, or light having another wavelength may be used.

The optical fiber 12 is a single-core fiber that propagates light having a wavelength used for communication in a single mode. In one or more embodiments, among the four optical fibers 12 connected to the ports TX, two optical fibers 12 are connected to the mode multiplexing/demultiplexing unit 15, and the other two optical fibers 12 are connected to optical interfaces 12T of the transceiver 10. The optical interface 12T is an interface that transmits light in the single mode. Note that the connection includes meaning of optical coupling, and light can be propagated between the devices connected to each other.

An optical fiber 11 is connected to the mode multiplexing/demultiplexing unit 15 on a side opposite to a side to which the optical fibers 12 are connected. The optical fiber 11 is a single-core fiber that propagates light having the wavelength used for communication in a multimode. In one or more embodiments, the optical fiber 11 propagates light in an LP01 mode and light in an LP11 mode. The mode multiplexing/demultiplexing unit 15 is formed by, for example, a spatial optical system using a waveguide, a lens, or the like, and emits light entering from one of the optical fibers 12 connected to the mode multiplexing/demultiplexing unit 15 to the optical fiber 11 with light in the LP01 mode, and emits light entering from the other optical fiber 12 to the optical fiber 11 with light in the LP11 mode. Therefore, the optical fiber 11 superimposes a signal superimposed on the light propagated through the one optical fiber 12 on light in the LP01 mode, and superimposes a signal superimposed on the light propagated through the other optical fiber 12 on light in the LP11 mode. A side of the optical fiber 11 opposite to a side connected to the mode multiplexing/demultiplexing unit 15 is connected to an optical interface 11T of the transceiver 10. The optical interface 11T is an interface that transmits light in the multimode.

Furthermore, the respective optical fibers 12 connected to the ports RX are connected to optical interfaces 12R of the transceiver 10. The optical interface 12R is an interface that receives light in the single mode.

Other optical fibers 12 are connected to the optical interfaces 12T and 12R from the outside of the transceiver 10. These optical fibers 12 have configurations similar to those of the optical fibers 12 in the transceiver 10. Another optical fiber 11 is connected to the optical interface 11T from the outside of the transceiver 10. The optical fiber 11 have a configuration similar to that of the optical fiber 11 in the transceiver 10.

The fan-in/fan-out device 16 includes a waveguide 161 and a plurality of waveguides 162. At least one of a diameter, a refractive index, and a refractive index profile is different between the waveguide 161 and the waveguides 162, and each of the waveguides 162 propagates light having the wavelength used for communication in the single mode, and the waveguide 161 propagates light having the wavelength used for communication in the multimode. In this example, the waveguide 161 propagates light having the wavelength used for communication with light in the LP01 mode and light in the LP11 mode. The waveguides 162 are individually connected to the other optical fibers 12 connected to the optical interfaces 12T and 12R, and the waveguide 161 is connected to the other optical fiber 11 connected to the optical interface 11T. Furthermore, the multi-core fiber for communication 2 is connected to a side of the fan-in/fan-out device 16 opposite to a side to which the optical fibers 11 and 12 are connected.

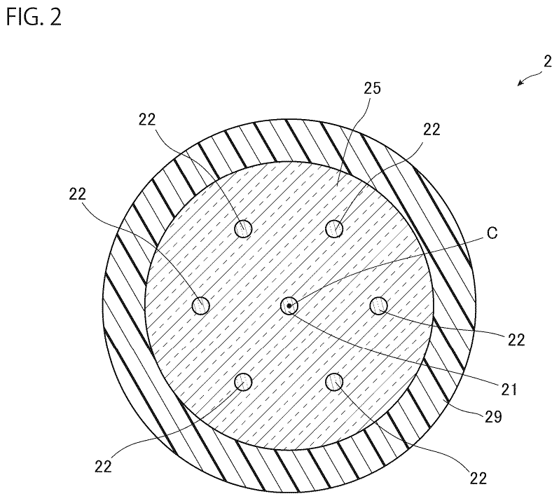

FIG. 2 is a cross-sectional view perpendicular to a longitudinal direction of the multi-core fiber for communication 2. As illustrated in FIG. 2, the multi-core fiber for communication 2 of this example includes a common cladding 25, one core 21 arranged at a center C of the common cladding 25, six cores 22 arranged so as to surround the center C of the common cladding 25, and a protective layer 29 that includes resin and covers an outer circumferential surface of the common cladding 25. The respective cores 22 are arranged at equal intervals on the same circumference centered on the center C. That is, the cores 21 and 22 of the multi-core fiber for communication 2 are arranged in so-called 1-6 arrangement. Note that the cores 22 arranged on the common circumference centered on the center C can be considered to have the same distance from the center. Therefore, in one or more embodiments, the cores 21 and 22 are arranged in a closest packing state and are arranged so as to be rotationally symmetric. Refractive indexes of the cores 21 and 22 are higher than that of the common cladding 25. At least one of a diameter, the refractive index, and a refractive index profile is different between the core 21 and the cores 22, and the core 21 propagates light having the wavelength used for communication in the multimode, and each of the cores 22 farthest from the center C of the common cladding 25 propagates light having the wavelength used for communication in the single mode. That is, the core 21 nearest to the center C of the common cladding 25 propagates light in a higher-order mode than the core 22 farthest from the center C. In this example, the core 21 propagates light having the wavelength used for communication with light in the LP01 mode and light in the LP11 mode. In this manner, the cores 21 and 22 are transmission paths that propagate light. Note that a marker may be arranged in the common cladding 25. A refractive index of the marker may be higher or lower than the refractive index of the common cladding 25. Furthermore, the marker is preferably arranged at a position where each of the cores 22 can be identified.

The core 21 is connected to the waveguides 161 of the fan-in/fan-out device 16, and the respective cores 22 are individually connected to the respective waveguides 162 of the fan-in/fan-out device 16. Therefore, the core 21 is optically coupled to the optical interface 11T of the transceiver 10, the respective two cores 22 among the six cores 22 are optically coupled to the optical interfaces 12T, and the respective remaining four cores 22 are optically coupled to the optical interfaces 12R. Therefore, in the optical communication device 1 on the lower side of FIG. 1, the core 21 and the two cores 22 of the multi-core fiber for communication 2 are transmission cores through which light transmitted from the ports TX is propagated, and the other four cores 22 of the multi-core fiber for communication 2 are reception cores through which light received at the ports RX is propagated.

The multi-core fiber for communication 2 connected to the fan-in/fan-out device 16 in the optical communication device 1 is connected to one end of another multi-core fiber for communication 2 at a connection portion 2C. The other end of the multi-core fiber for communication 2 is connected to the multi-core fiber for communication 2 of the other optical communication device 1 positioned on an upper side in the drawing.

The other optical communication device 1 is different from the one optical communication device 1 in the following points. In the other optical communication device 1, the optical interface 12R in the transceiver 10 of the one optical communication device 1 is the optical interface 12T, the optical interface 12T is the optical interface 12R, and the optical interface 11T is an optical interface 11R. In the other optical communication device 1, the optical interface 12T is an interface that transmits light in the single mode, the optical interface 12R is an interface that receives light in the single mode, and the optical interface 11R is an interface that receives light in the multimode. The optical interfaces 12T are connected to the ports TX of the circuit unit 14 via the optical fibers 12, and the optical interfaces 12R are connected to the ports RX via the optical fibers 12. Furthermore, the optical interface 11R is connected to the two ports RX via the optical fiber 11, the mode multiplexing/demultiplexing unit 15, and the two optical fibers 12. Therefore, the respective ports TX of the one optical communication device 1 are optically coupled to the respective ports RX of the other optical communication device 1 via the cores 21 and 22 of the multi-core fiber for communication 2, and the respective ports RX of the one optical communication device 1 are optically coupled to the respective ports TX of the other optical communication device 1 via the core 22 of the multi-core fiber for communication 2.

Next, an operation of the optical communication system 100 will be described.

In the one optical communication device 1 described on the lower side of the page of FIG. 1, the circuit unit 14 of the transceiver 10 transmits light on which signals are superimposed from the respective ports TX to the optical fibers 12. The light from the port TX entering the optical fiber 12 connected to the port TX and the optical interface 12T enters, as light in the single mode, the waveguide 162 of the fan-in/fan-out device 16 from the optical fiber 12 via another optical fiber 12 connected to the optical interface 12T. The light propagating through the waveguide 162 of the fan-in/fan-out device 16 enters, as the light in the single mode, the core 22 of the multi-core fiber for communication 2 from the waveguide 162. The light from the ports TX entering the optical fibers 12 connected to the ports TX and the mode multiplexing/demultiplexing unit 15 enters the mode multiplexing/demultiplexing unit 15 from the optical fibers 12, and the light entering from one of the optical fibers 12 is multiplexed as light in the LP01 mode and the light entering from the other optical fiber 12 is multiplexed as light in the LP11 mode to be light in the multimode. Therefore, signals superimposed on the light transmitted from the port TX to the one optical fiber 12 connected to the mode multiplexing/demultiplexing unit 15 are superimposed on the light in the LP01 mode, and signals superimposed on the light transmitted from the port TX to the other optical fiber 12 connected to the mode multiplexing/demultiplexing unit 15 are superimposed on the light in the LP11 mode. Note that the LP11 mode is a degeneration mode that can be divided into an LP11a mode and an LP11b mode. However, in this example, the mode multiplexing/demultiplexing unit 15 treats the light in the LP11 mode as light in one mode without performing the division into the LP11a mode and the LP11b mode. That is, the transceiver 10 including the mode multiplexing/demultiplexing unit 15 treats the light in the LP11 mode as the light in one mode without performing the division into the LP11a mode and the LP11b mode. The light in the multimode obtained by the multiplexing by the mode multiplexing/demultiplexing unit 15 enters the optical fiber 11, and enters the waveguide 161 of the fan-in/fan-out device 16 from the optical fiber 11 via another optical fiber 11 connected to the optical interface 11T. By treating the light in the degeneration mode as one light in this manner, intensity of the light can be increased, S/N can be improved, and communication quality can be improved. The light propagating through the waveguide 161 of the fan-in/fan-out device 16 is emitted from the waveguide 161 and enters the core 21 of the multi-core fiber for communication 2 as the light in the multimode.

The light propagating through the cores 21 and 22 of the multi-core fiber for communication 2 of the one optical communication device 1 illustrated on the lower side of FIG. 1 enters the cores 21 and 22 of the other multi-core fiber for communication 2 at the connection portion 2C, and propagates through the cores 21 and 22. The light propagating through the cores 21 and 22 of the other multi-core fiber for communication 2 enters the cores 21 and 22 of the multi-core fiber for communication 2 of the other optical communication device 1 illustrated on the upper side of FIG. 1 at the connection portion 2C. At this time, since the cores 22 are single mode cores, even when the respective multi-core fibers for communication 2 connected at the connection portion 2C are axially deviated in a rotation direction, the light propagating through the cores 22 is suppressed from being coupled to light in a higher-order mode. Furthermore, since the core 21 is positioned at the center C of the common cladding 25, even in a case where there is the axial deviation in the rotation direction, the light propagating through the core 21 is suppressed from being coupled to light in a higher-order mode.

The light propagating through the core 22 of the multi-core fiber for communication 2 of the other optical communication device 1 is received at the ports RX in the circuit unit 14 of the transceiver 10 via the waveguides 162 of the fan-in/fan-out device 16, the optical fibers 12, the optical interfaces 12R of the transceiver 10, and the optical fibers 12 in the transceiver 10. The light propagating through the core 21 of the multi-core fiber for communication 2 of the other optical communication device 1 enters the mode multiplexing/demultiplexing unit 15 via the waveguide 161 of the fan-in/fan-out device 16, the optical fiber 11, the optical interface 11R, and the optical fiber 11 in the transceiver 10. The light includes light in the LP01 mode and light in the LP11 mode, and light in the LP01 mode and light in the LP11 mode are demultiplexed in the mode multiplexing/demultiplexing unit 15. Each of the light obtained by the demultiplexing enters each of the optical fibers 12 connected to the mode multiplexing/demultiplexing unit 15 as the light in the single mode, and is received at the ports RX in the circuit unit 14 of the transceiver 10 via the optical fibers 12. The received light is subjected to signal processing in the circuit unit 14. At this time, by treating the light in the degeneration mode as one light, the signal processing such as MIMO in the circuit unit 14 can be reduced.

In this manner, the light on which the signals are superimposed is transmitted from the one optical communication device 1 to the other optical communication device.

Furthermore, in the other optical communication device 1 described on the upper side of the page of FIG. 1, the transceiver 10 transmits the light on which the signals are superimposed from the respective ports TX of the circuit unit 14 to the optical fibers 12. The respective optical fibers 12 connected to the ports TX are connected to the waveguides 162 of the fan-in/fan-out device 16 via the optical interfaces 12T and the optical fibers 12 outside the transceiver 10. Therefore, the light from the ports TX enters the waveguides 162. The light propagating through the waveguides 162 enters the cores 22 of the multi-core fiber for communication 2 in the other optical communication device 1 from the waveguides 162, and enters, from the cores 22 of the multi-core fiber for communication 2, the cores 22 of the multi-core fiber for communication 2 connecting the respective optical communication devices 1 via the connection portion 2C. These light beams propagate to the cores 22 of the multi-core fiber for communication 2 of the one optical communication device 1 via the connection portion 2C. Then, the light emitted from the cores 22 is received at the ports RX of the circuit unit 14 via the waveguides 162 of the fan-in/fan-out device 16, the optical fibers 12 outside the transceiver 10, the optical interfaces 12R, and the optical fibers 12 in the transceiver 10. Note that, also in this case, since the cores 22 of the multi-core fiber for communication 2 are single mode cores, even in a case where the respective multi-core fibers for communication 2 connected to each other at the connection portion 2C are axially deviated in the rotation direction, the light propagating through the cores 22 is suppressed from being coupled to light in a higher-order mode.

In this manner, the light on which the signals are superimposed is transmitted from the other optical communication device 1 to the one optical communication device.

As described above, in the multi-core fiber for communication 2 of one or more embodiments, the core 21 that is the transmission path nearest to the center C of the common cladding 25 propagates light in a higher-order mode than the cores 22 that are the transmission paths farthest from the center C. Furthermore, the optical communication device 1 of one or more embodiments includes the multi-core fiber for communication 2 in which the core 21 that is the transmission path nearest to the center C of the common cladding 25 propagates light in a higher-order mode than the cores 22 that are the transmission paths farthest from the center C, and the transceiver 10 that performs at least one of transmission and reception of light by the plurality of cores 21 and 22, in which the core 21 that is the transmission path nearest to the center C of the common cladding 25 propagates light in a higher-order mode than the cores 22 that are the transmission paths farthest from the center C.

According to the multi-core fiber for communication 2 of one or more embodiments, mode division multiplex communication can be performed in the core 21 that propagates light in a plurality of modes. Therefore, an amount of signals to be propagated can be increased as compared with a multi-core fiber for communication in which each of the cores 21 and 22 includes a single mode core. Since the core 21 nearest to the center C of the common cladding 25 propagates light in a higher-order mode than the cores 22 farthest from the center C, the number of modes of light propagating through the cores 22 farthest from the center C of the common cladding 25 is smaller than the number of modes of light propagating through the core 21 nearest to the center C. Therefore, even in a case where misalignment in the rotation direction occurs in the connection portion 2C and positional displacement is caused by the cores 22 on the outer circumferential side of the common cladding 25 in the connection portion 2C between the multi-core fiber for communication 2 of the optical communication device 1 and the other multi-core fiber for communication 2, light propagating through the cores 22 is less likely to be coupled to light in another mode as compared with a case where the cores 22 propagate light in the same number of modes as the light propagating through the core 21. Therefore, according to the multi-core fiber for communication 2 of one or more embodiments, it is possible to suppress deterioration in transmission quality of the light to be propagated. Therefore, according to the multi-core fiber for communication 2 and the optical communication device 1 of one or more embodiments, it is possible to suppress the deterioration in the transmission quality of the light while increasing the amount of signals to be propagated.

Furthermore, in the multi-core fiber for communication 2 of one or more embodiments, the cores 21 and 22 that are the transmission paths are arranged so as to be rotationally symmetric. Therefore, when the multi-core fiber for communication 2 is connected to the other multi-core fiber for communication 2, alignment in the rotation direction is easy.

Furthermore, in the multi-core fiber for communication 2 of one or more embodiments, the cores 21 and 22 that are the transmission paths are arranged in a closest packing state. Therefore, a common cladding diameter can be made small as compared with a multi-core fiber for communication having the same number of cores in which the cores are not arranged in a closest packing state.

Furthermore, in the multi-core fiber for communication 2 of one or more embodiments, the cores 22 that are the transmission paths farthest from the center C of the common cladding 25 are the single mode cores. Therefore, in the connection portion 2C, mode coupling of the light propagating through the cores 22 can be suppressed.

Furthermore, in the optical communication device 1 of one or more embodiments, the transceiver 10 transmits light to a part of the cores 21 and 22 of the multi-core fiber for communication 2 and receives light propagating through another part of the cores 22. Therefore, the light can be transmitted and received using the one multi-core fiber for communication 2. In this case, since a transmission core and a reception core are allocated to the plurality of cores 21 and 22 of the multi-core fiber for communication 2, deterioration in the communication quality due to crosstalk can be suppressed between the transmission core and the reception core adjacent to each other. Specifically, even when crosstalk of the light propagating through the transmission core with the reception core is caused, the light for which the crosstalk with the reception core is caused propagates in an opposite direction to light on which signals are superimposed propagating through the reception core. Therefore, it is possible to suppress the deterioration in the communication quality as described above.

Furthermore, in the optical communication device 1 of one or more embodiments, in a case where the transceiver 10 counts light beams in different modes propagating through the core 21 and light beams propagating through the cores 22 different from each other as different light beams, a sum of the number of light beams to be transmitted to the cores 21 and 22 by superimposing signals and the number of light beams to be received from the core 22, on which signals are superimposed, is an even number. In optical communication, a sum of the number of ports TX and the number of ports RX may be an even number. Therefore, according to the optical communication device 1 of one or more embodiments, even in such a case, it is possible to transmit and receive the light while suppressing waste using the one multi-core fiber for communication 2.

Furthermore, in the optical communication device 1 of one or more embodiments, in a case where the transceiver 10 counts the light beams in the different modes propagating through the core 21 and the light beams propagating through the cores 22 different from each other as the different light beams, signals are superimposed on light beams of the number of multiples of 2 and the light beams are transmitted to the cores 21 and 22, and the light beams of the number of multiples of 2 on which the signals are superimposed are received from the core 22. In the optical communication, the number of ports TX and ports RX may be a multiple of 2. According to such an optical communication device 1, even in such a case, it is possible to transmit and receive the light using the one multi-core fiber for communication 2.

Furthermore, in the optical communication device 1 of one or more embodiments, the number of light beams transmitted from the transceiver 10 to the cores 21 and 22 is equal to the number of light beams received from the core 22. In the optical communication, the number of ports TX and ports RX may be equal to each other. According to such an optical communication device 1, even in such a case, it is possible to transmit and receive the light using the one multi-core fiber for communication 2.

Note that, in the above embodiments, an example has been described in which the core 21 propagates light in the two modes and each of the cores 22 propagates light in the single mode, but one or more embodiments are not limited thereto. An example of the number of modes of light used for communication propagated through the cores 21 and 22 is illustrated in Table 1. Note that Example 1 in Table 1 is an example of the above embodiments.

TABLE 1

| | The number of propagation modes | | Total number of |
|---|---|---|---|
| | Core 21 | Core 22 | light beams |
| Example 1 | 2 | 1 | 8 |
| Example 2 | 4 | 1 | 10 |
| Example 3 | 6 | 1 | 12 |
| Example 4 | 10 | 1 | 16 |
| Example 5 | 6 | 3 | 24 |

Example 2 is different from the above embodiments in that the core 21 propagates light in four modes. In this case, light beams in the respective modes of LP01, LP11, LP21, and LP02 propagate through the core 21. In this example, in a case where the light beams in the respective modes propagating through the cores 21 and 22 are counted as different light beams, the total number of light beams propagating through the multi-core fiber for communication 2 is 10. Therefore, in the case of this example, the total number of the ports TX and RX of the circuit unit 14 is 10. Note that the number of one of the ports TX and RX is four or more. Note that, in this example, the LP11 mode is the degeneration mode including the LP11a mode and the LP11b mode, and the LP21 mode is a degeneration mode including an LP21a mode and an LP21b mode. However, the transceiver 10 treats each of the degeneration modes as one mode. In the case of this example, for example, the number of light beams used for each of transmission and reception can be five.

Example 3 is different from the above embodiments in that the core 21 propagates light in six modes. In this case, light beams in the respective modes of LP01, LP11a, LP11b, LP21a, LP21b, and LP02 propagate through the core 21. In this example, in a case where the light beams in the respective modes propagating through the cores 21 and 22 are counted as different light beams, the total number of light beams propagating through the multi-core fiber for communication 2 is 12. Therefore, in the case of this example, the total number of the ports TX and RX of the circuit unit 14 is 12. Note that the number of one of the ports TX and RX is six or more. In this example, each of the light beams in the LP11 mode and the LP21 mode, which are the degeneration modes, is separated into two modes, and treated as the LP11a mode and the LP11b mode, and the LP21a mode and the LP21b mode. In the case of this example, for example, the number of light beams used for each of transmission and reception can be six.

Example 4 is different from the above embodiments in that the core 21 propagates light in 10 modes. In this case, light beams in the respective modes of LP01, LP11a, LP11b, LP21a, LP21b, LP02, LP31a, LP31b, LP12a, and LP12b propagate through the core 21. In this example, in a case where the light beams in the respective modes propagating through the cores 21 and 22 are counted as different light beams, the total number of light beams propagating through the multi-core fiber for communication 2 is 16. Therefore, in the case of this example, the total number of the ports TX and RX of the circuit unit 14 is 16. Note that the number of one of the ports TX and RX is 10 or more. In this example, each of the light beams in the LP11 mode, the LP21 mode, an LP31 mode, and an LP12 mode, which are the degeneration modes, is treated as two modes, that are, the LP11a mode and the LP11b mode, the LP21a mode and the LP21b mode, the LP31a mode and the LP31b mode, and the LP12a mode and the LP12b mode. In the case of this example, for example, the number of light beams used for one of transmission and reception can be 10, and for the other can be six.

Example 5 is different from the above embodiments in that the core 21 propagates light in six modes, and each of the cores 22 propagates light in three modes. In this case, light beams in the respective modes of LP01, LP11a, LP11b, LP21a, LP21b, and LP02 propagate through the core 21, and light beams in the respective modes of LP01, LP11a, and LP11b propagate through the core 22. In this example, in a case where the light beams in the respective modes propagating through the cores 21 and 22 are counted as different light beams, the total number of light beams propagating through the multi-core fiber for communication 2 is 24. Therefore, in the case of this example, the total number of the ports TX and RX of the circuit unit 14 is 24. Note that the number of one of the ports TX and RX is six or more, and the other is three or more. In this example, each of the light beams in the LP11 mode and the LP21 mode, which are the degeneration modes propagating through the core 21, is treated as the two modes, that are, the LP11a mode and the LP11b mode, and the LP21a mode and the LP21b mode, and light in the LP11 mode, which is the degeneration mode propagating through the core 22, is treated as the two modes, that are, the LP11a mode and the LP11b mode. In the case of this example, for example, the number of light beams used for each of transmission and reception can be 12.

Next, modifications of one or more embodiments will be described.

### First Modification

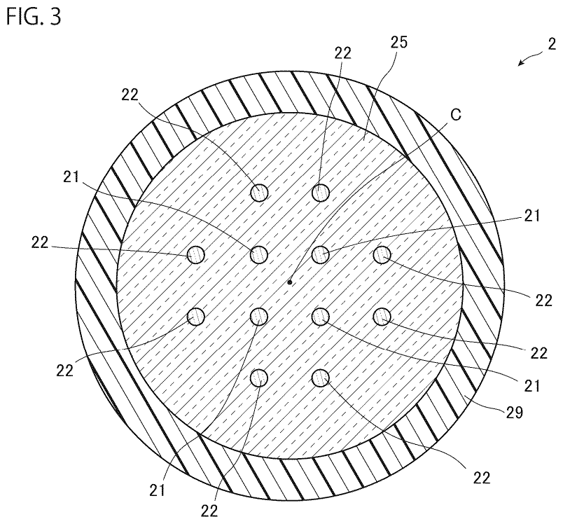

FIG. 3 is a view illustrating a state of a cross section perpendicular to the longitudinal direction of a first modification of the multi-core fiber for communication 2. As illustrated in FIG. 3, in the multi-core fiber for communication 2 of the present modification, the cores 21 are arranged on the respective apexes of a square surrounding the center C of the common cladding 25 and on the same circumference centered on the center C, and the eight cores 22 are arranged on the same circumference centered on the center C so as to surround the four cores 21. That is, the four cores 21 are arranged at equal distances from the center C of the common cladding 25, and the eight cores 22 are arranged at equal distances from the center C of the common cladding 25. Therefore, the cores 21 and 22 are arranged so as to have rotational symmetry of 90 degrees. For example, each of the cores 21 propagates light in two modes similarly to the above embodiments, and the core 22 propagates light in the single mode similarly to the above embodiments. In this case, in a case where the light beams in the respective modes propagating through the cores 21 and 22 are counted as different light beams, the total number of light beams propagating through the multi-core fiber for communication 2 is 20. Note that the number of modes of the light propagating through the cores 21 and the cores 22 may be similar to those in Examples 2 to 5 in Table 1. Note that, in the case of this example, it is preferable that directions of the light beams propagating through the cores adjacent to each other are different from each other. That is, it is preferable that one of the cores adjacent to each other is a transmission core and the other is a reception core. In the case of this example, in all the adjacent cores, one can be the transmission core and the other can be the reception core.

### Second Modification

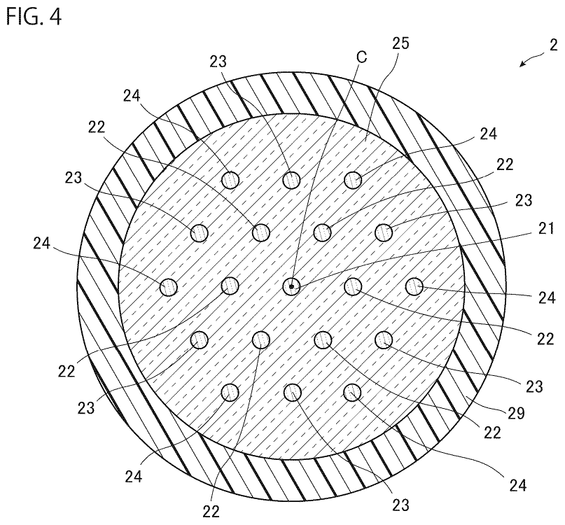

FIG. 4 is a view illustrating a state of the cross section perpendicular to the longitudinal direction of a second modification of the multi-core fiber for communication 2. As illustrated in FIG. 3, the multi-core fiber for communication 2 of the present modification is different from the multi-core fiber for communication 2 of the above embodiments in that 12 cores 23 and 24 are provided on the outer circumferential side of the cores 21 and 22 of the above embodiments. The respective cores 23 are arranged on midpoints of sides of a hexagon formed by connecting the cores 23 and 24, and the respective cores 24 are arranged on apexes of the hexagon. In this case, the cores 21 to 24 are arranged in a closest packing state and arranged so as to have rotational symmetry of 60 degrees. Furthermore, the respective cores 22 are arranged on a common circle centered on the center C of the common cladding 25, the respective cores 23 are arranged on another common circle centered on the center C, and the respective cores 24 are arranged on still another common circle centered on the center C. Therefore, the respective cores 22 are arranged at equal distances from the center C, the respective cores 23 are arranged at equal distances from the center C, and the respective cores 24 are arranged at equal distances from the center C. In the present modification, the number of modes of light used for communication propagating through the cores 21 to 24 is, for example, as indicated in Table 2 below. Note that, in this example, it is preferable that one of the cores 21 adjacent to each other is a transmission core and the other is a reception core, and one of the core 23 and the core 24 is a transmission core and the other is a reception core.

TABLE 2

| | The number of propagation modes | | | | Total number of |
|---|---|---|---|---|---|
| | Core 21 | Core 22 | Core 23 | Core 24 | light beams |
| Example 6 | 2 | 1 | 1 | 1 | 20 |
| Example 7 | 4 | 1 | 1 | 1 | 22 |
| Example 8 | 6 | 1 | 1 | 1 | 24 |
| Example 9 | 10 | 1 | 1 | 1 | 28 |
| Example 10 | 6 | 3 | 1 | 1 | 36 |
| Example 11 | 6 | 3 | 3 | 3 | 60 |
| Example 12 | 6 | 6 | 1 | 1 | 54 |

Example 6 is an example in which the core 21 propagates light in two modes, and the cores 22, 23, and 24 propagate light in the single mode. In this case, light beams in the LP01 mode and the LP11 mode are propagated through the core 21 in a manner similar to that in the above Example 1. In this case, in a case where the light beams in the respective modes propagating through the cores 21 to 24 are counted as different light beams, the total number of light beams propagating through the multi-core fiber for communication 2 is 20. In the case of this example, for example, the number of light beams used for each of transmission and reception can be 10.

Example 7 is an example in which the core 21 propagates light in four modes, and the cores 22, 23, and 24 propagate light in the single mode. In this case, as in the above Example 2, light beams in the respective modes of LP01, LP11, LP21, and LP02 propagate through the core 21. In this case, in a case where the light beams in the respective modes propagating through the cores 21 to 24 are counted as different light beams, the total number of light beams propagating through the multi-core fiber for communication 2 is 22. In the case of this example, for example, the number of light beams used for each of transmission and reception can be 11.

Example 8 is an example in which the core 21 propagates light in six modes, and the cores 22, 23, and 24 propagate light in the single mode. In this case, as in the above Example 3, light beams in the respective modes of LP01, LP11a, LP11b, LP21a, LP21b, and LP02 propagate through the core 21. In this case, in a case where the light beams in the respective modes propagating through the cores 21 to 24 are counted as different light beams, the total number of light beams propagating through the multi-core fiber for communication 2 is 24. In the case of this example, for example, the number of light beams used for each of transmission and reception can be 12.

Example 9 is an example in which the core 21 propagates light in 10 modes, and the cores 22 and 23 propagate light in the single mode. In this case, as in the above Example 4, light beams in the respective modes of LP01, LP11a, LP11b, LP21a, LP21b, LP02, LP31a, LP31b, LP12a, and LP12b propagate through the core 21. In this case, in a case where the light beams in the respective modes propagating through the cores 21 to 24 are counted as different light beams, the total number of light beams propagating through the multi-core fiber for communication 2 is 28. In the case of this example, for example, the number of light beams used for each of transmission and reception can be 14.

Example 10 is an example in which the core 21 propagates light in six modes, the core 22 propagates light in three modes, and the core 23 propagates light in the single mode. As in the above Example 3, light beams in the respective modes of LP01, LP11a, LP11b, LP21a, LP21b, and LP02 propagate through the core 21, and as in Example 5, light beams in the respective modes of LP01, LP11a, and LP11b propagate through the core 22. In this case, in a case where the light beams in the respective modes propagating through the cores 21 to 24 are counted as different light beams, the total number of light beams propagating through the multi-core fiber for communication 2 is 36. In the case of this example, for example, the number of light beams used for each of transmission and reception can be 18.

Example 11 is an example in which the core 21 propagates light in six modes, and the cores 22 and 23 propagate light in three modes. As in the above Example 3, light beams in the respective modes of LP01, LP11a, LP11b, LP21a, LP21b, and LP02 propagate through the core 21, and as in Example 5, light beams in the respective modes of LP01, LP11a, and LP11b propagate through the cores 22 and 23. In this case, in a case where the light in the respective modes propagating through the cores 21 to 24 are counted as different light beams, the total number of light beams propagating through the multi-core fiber for communication 2 is 60. In the case of this example, for example, the number of light beams used for each of transmission and reception can be 30.

Example 12 is an example in which the cores 21 and 22 propagate light in six modes, and the core 23 propagates light in the single mode. As in the above Example 3, light beams in the respective modes of LP01, LP11a, LP11b, LP21a, LP21b, and LP02 propagate through the cores 21 and 22. In this case, in a case where the light beams in the respective modes propagating through the cores 21 to 24 are counted as different light beams, the total number of light beams propagating through the multi-core fiber for communication 2 is 54. In the case of this example, for example, the number of light beams used for each of transmission and reception can be 27.

Note that, in the case of this example, although not described in Table 2, for example, the nearer to the center C of the common cladding 25, light in a higher-order mode may be propagated. In this case, for example, the core 21 propagates light in six modes, the core 22 propagates light in four modes, the core 23 propagates light in two modes, and the core 24 propagates light in the single mode. In this case, the number of modes of light to be propagated is smaller in a transmission path on the outer circumferential side where positional displacement is more likely to be large at a connection portion with another multi-core fiber for communication, so that deterioration in transmission quality of the light to be propagated can be further suppressed.

### Third Modification

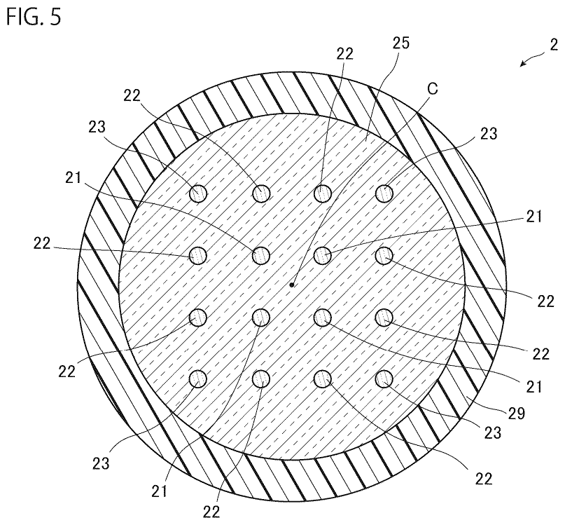

FIG. 5 is a view illustrating a state of the cross section perpendicular to the longitudinal direction of a third modification of the multi-core fiber for communication 2. As illustrated in FIG. 5, in the multi-core fiber for communication 2 of the present modification, the cores 21 are arranged on the respective apexes of a square surrounding the center C of the common cladding 25, the eight cores 22 are arranged so as to surround the four cores 21, and cores 23 are arranged on the respective apexes of a square having sides passing through the respective cores 22. In this manner, the cores 21, 22, and 23 are arranged in a square lattice pattern. Therefore, the cores 21, 22, and 23 are arranged so as to have rotational symmetry of 90 degrees. In this case, the number of modes of light propagating through the cores 21, 22, and 23 is, for example, set to be similar to that in Table 2. When the number of modes of light propagating through the cores 21, 22, and 23 is the same as that in the Example 10, the nearer to the center C of the common cladding 25, light in a higher-order mode is propagated. In this case, the number of modes of light to be propagated is smaller in a transmission path on the outer circumferential side where positional displacement is more likely to be large at a connection portion with another multi-core fiber for communication, so that deterioration in transmission quality of the light to be propagated can be further suppressed.

### Fourth Modification

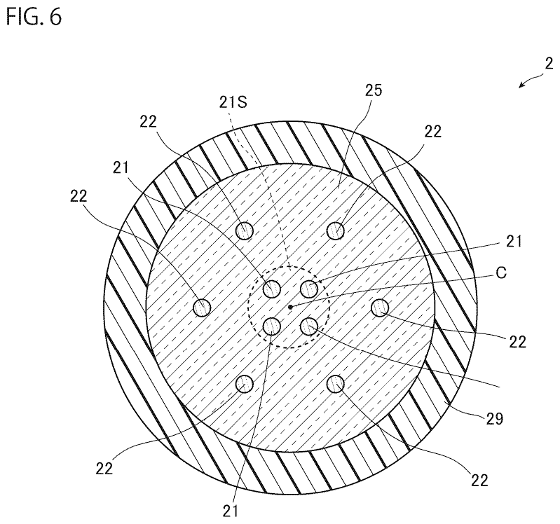

FIG. 6 is a view illustrating a state of the cross section perpendicular to the longitudinal direction of a fourth modification of the multi-core fiber for communication 2. As illustrated in FIG. 6, in the multi-core fiber for communication 2 of the present modification, the cores 21 are arranged on the respective apexes of a square surrounding the center C of the common cladding 25, and the six cores 22 are arranged so as to surround the four cores 21. In one or more embodiments, the four cores 21 are coupled cores that couple light propagating to each other. Therefore, the multi-core fiber for communication 2 of the present modification includes one transmission path 21S including the four cores 21 and six transmission paths including the cores 22. In the transmission path 21S, light in a super mode is formed by light propagating through each of the cores 21, and light in the same number of modes as the number of cores 21 is propagated. Therefore, the present modification can be considered similarly to Example 2 in Table 1, and in a case where light beams in the respective modes propagating through the transmission path 21S and the respective cores 22 are counted as different light beams, the total number of light beams propagating through the multi-core fiber for communication 2 is 10. Note that, in the present modification, the number of cores 21 of the transmission path 21S may be plural other than four. Note that, in the case of this example, it is preferable that the respective cores 21 constituting the transmission path 21S are arranged on a circumference centered on the center C of the common cladding 25. In this case, the respective cores 21 are arranged at equal distances from the center C. Furthermore, the number of modes of light propagating through the respective cores 22 may be plural as long as the number of modes is smaller than the number of modes of light propagating through the transmission path 21S. Therefore, the cores 22 may be coupled cores in which a plurality of cores is coupled to each other. For example, in a case where the transmission path 21S transmits light in four modes as in this example, each of the cores 22 may be replaced with a transmission path including three cores coupled to each other. In this case, six transmission paths each including three cores are formed on a circumference centered on the center C of the common cladding 25. The fact that the transmission paths each including the plurality of cores are arranged on the circumference centered on the center C in this manner means that any one of the cores coupled to each other is only required to be positioned on the circumference, and in this case, the respective transmission paths are arranged at equal distances from the center C.

The number of ports TX and RX and the configuration of the mode multiplexing/demultiplexing unit 15 of the optical communication device 1 can be appropriately changed in accordance with the above modifications.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

For example, in the above embodiments, an example has been described in which the optical communication device 1 includes the ports TX and RX in the circuit unit 14, and the transceiver 10 performs both transmission and reception of light. That is, the transceiver 10 may perform one of the transmission and reception of light. In this case, the circuit unit 14 includes only the ports TX or only the ports RX.

Furthermore, in the above embodiments, an example has been described in which each of light beams in all modes that can be propagated by the cores 21 and 22 and the like is used, and signals are superimposed on the light beam in each mode. However, the transceiver 10 does not have to use a part of the modes among the modes of the light beams that can be propagated by the cores 21 and 22 and the like. In this case, the signals do not have to be superimposed on the light beams that are not used.

Furthermore, the configuration of the transceiver 10 is not limited to that of the above embodiments. For example, the fan-in/fan-out device 16 may be connected directly to the transceiver 10 not via the optical fibers 11 and 12 outside the transceiver 10, and the fan-in/fan-out device 16 may be included in the transceiver 10. Furthermore, at least one of the optical fibers 11 and 12 in the transceiver 10 and the optical fibers 11 and 12 outside the transceiver 10 may be replaced with a substrate-type optical waveguide. Examples of a substrate-type optical waveguide substrate include a polymer waveguide, silicon photonics, and a quartz-based planar optical circuit. Furthermore, the mode multiplexing/demultiplexing unit 15 may be provided in the circuit unit 14 and integrally integrated on a substrate of an optical IC chip, or may be provided outside the circuit unit 14 as in the above embodiments and connected via an optical fiber or a waveguide device. In the above embodiments, an example has been described in which the optical communication device 1 includes the one transceiver 10. However, the optical communication device 1 may include a plurality of the transceivers 10. For example, a transceiver that transmits and receives only light in the single mode and a transceiver that transmits and receives only light in the multimode may be included.

As described above, according to one or more embodiments, there are provided the multi-core fiber for communication and the optical communication device capable of suppressing deterioration in transmission quality of light while increasing an amount of signals to be propagated, and the multi-core fiber for communication and the optical communication device can be used in the field of optical communication and the like.

1. A multi-core fiber for communication comprising:
transmission paths that each include a single core or multiple cores mode-coupled to each other; and
a common cladding that surrounds an outer circumferential surface of the single core of each of the transmission paths or each of the multiple cores of each of the transmission paths, wherein
a first transmission path of the transmission paths closest to a center of the common cladding propagates light in a higher-order mode than a second transmission path of the transmission paths farthest from the center.

2. The multi-core fiber according to claim 1, wherein the transmission paths closer to the center propagate light in higher-order modes.

3. The multi-core fiber according to claim 1, wherein two or more of the transmission paths disposed-arranged at equal distances from the center propagate light in the same mode.

4. The multi-core fiber according to claim 1, wherein the transmission paths are disposed rotationally symmetric about the center.

5. The multi-core fiber according to claim 1, wherein one of the transmission paths includes the single core and is disposed in a closest packing state.

6. The multi-core fiber according to claim 1, wherein one of the transmission paths including the cores mode-coupled to each other is disposed at the center.

7. The multi-core fiber according to claim 1, wherein
one of the transmission paths disposed at the center propagates the light in the higher-order mode, and
the others of the transmission paths disposed at other than the center is a single mode core.

8. The multi-core fiber according to claim 1, wherein the second transmission path is a single mode core.

9. An optical communication device comprising:
a multi-core fiber for communication including:
transmission paths that each include a single core or multiple cores mode-coupled to each other; and
a common cladding that surrounds an outer circumferential surface of the single core or each of the multiple cores of each of the transmission paths; and
a transceiver that performs at least one of transmission and reception of light through the transmission paths, wherein
a first transmission path of the transmission paths closest to a center of the common cladding propagate light in a higher-order mode than a second transmission path of the transmission paths farthest from the center.

10. The optical communication device according to claim 9, wherein the transceiver transmits light to one or more of the transmission paths and receives light propagating through the others of the transmission paths.

11. The optical communication device according to claim 10, wherein when the transceiver counts light beams in each mode propagating through each of the transmission paths as different light beams, a sum of a total number of light beams that the transceiver transmits to the transmission paths by superimposing signals and a total number of light beams that the transceiver receives from the transmission paths on which signals are superimposed is an even number.

12. The optical communication device according to claim 11, wherein the transceiver:
superimposes signals on each of an even number of outgoing light beams and transmits the outgoing light beams to at least one of the transmission paths, and
receives each of an even number of incoming light beams on which signals are superimposed from at least one of the transmission paths.

13. The optical communication device according to claim 12, wherein a total number of the outgoing light beams is equal to a total number of the incoming light beams.

14. The optical communication device according to claim 9, wherein the transceiver treats a degeneration mode of light propagating through one of the transmission paths as a single mode.

15. The optical communication device according to claim 9, wherein the transceiver does not use some of a plurality of modes of light propagating through the transmission paths.
